(19) United States
(12) Patent Application Publication
(10) Pub. No.: US 2006/0025169 A1
(43) Pub. Date: Feb. 2, 2006

(54) Apparatus and method capable of radio selection in a wireless device

(76) Inventors: Christian Maciocco, Tigard, OR (US); Vivek G. Gupta, Portland, OR (US); Uttam K. Sengupta, Portland, OR (US); Tsung-Yuan Tai, Portland, OR (US)

Correspondence Address: INTEL CORPORATION, P.O. BOX 5326, SANTA CLARA, CA, 95056-5326, US

(21) Appl. No.: 10/902,731

(22) Filed: Jul. 29, 2004

(51) Int. Cl. H04B 7/00; H04Q 7/20

(52) U.S. Cl. 455/525; 455/435.1

(57) ABSTRACT

A wireless device, comprising a plurality of radios wherein at least two of the plurality of radios are capable of operating within predetermined parameters. The wireless device may further include modules capable of dynamically selecting the most appropriate radio based on the predetermined parameters. The predetermined parameters may be predetermined power levels and the modules may select the most appropriate radio based on power requirements determined by systems profiles. In addition to or in lieu of the predetermined power levels, the modules may select the most appropriate radio based on requirements determined by network conditions.

### BACKGROUND

In today's wireless environment numerous devices are present and may be connected wirelessly. Further, in today's wireless environment there are a large number of wireless devices that are mobile and therefore must operate on battery power. Also, there are a large number of devices that utilize different wireless technologies and standards to transmit and receive wireless information.

Thus, there is a continuing need for better ways for wireless devices to improve performance, longevity of operation and interoperability among differing wireless technologies.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is an illustration of architecture of a software framework of one embodiment of the present invention;

FIG. 2 is a flowchart illustrating a radio selection heuristic based on a packet to send in one embodiment of the present invention.

It will be appreciated that for simplicity and clarity of illustration, elements illustrated in the figures have not necessarily been drawn to scale. For example, the dimensions of some of the elements are exaggerated relative to other elements for clarity. Further, where considered appropriate, reference numerals have been repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Some portions of the detailed description that follow are presented in terms of algorithms and symbolic representations of operations on data bits or binary digital signals within a computer memory. These algorithmic descriptions and representations may be the techniques used by those skilled in the data processing arts to convey the substance of their work to others skilled in the art.

An algorithm is generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. An apparatus may be specially constructed for the desired purposes, or it may comprise a general purpose computing device selectively activated or reconfigured by a program stored in the device. Such a program may be stored on a storage medium, such as, but not limited to, any type of disk including floppy disks, optical disks, compact disc read only memories (CD-ROMs), magnetic-optical disks, read-only memories (ROMs), random access memories (RAMs), electrically programmable read-only memories (EPROMs), electrically erasable and programmable read only memories (EEPROMs), magnetic or optical cards, or any other type of media suitable for storing electronic instructions, and capable of being coupled to a system bus for a computing device.

The processes and displays presented herein are not inherently related to any particular computing device or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein. In addition, it should be understood that operations, capabilities, and features described herein may be implemented with any combination of hardware (discrete or integrated circuits) and software.

Use of the terms “coupled” and “connected”, along with their derivatives, may be used. It should be understood that these terms are not intended as synonyms for each other. Rather, in particular embodiments, “connected” may be used to indicate that two or more elements are in direct physical or electrical contact with each other. “Coupled” my be used to indicated that two or more elements are in either direct or indirect (with other intervening elements between them) physical or electrical contact with each other, and/or that the two or more elements co-operate or interact with each other (e.g. as in a cause an effect relationship).

It should be understood that embodiments of the present invention may be used in a variety of applications. Although the present invention is not limited in this respect, the devices disclosed herein may be used in many apparatuses such as in the transmitters and receivers of a radio system. Radio systems intended to be included within the scope of the present invention include, by way of example only, cellular radiotelephone communication systems, satellite communication systems, two-way radio communication systems, one-way pagers, two-way pagers, personal communication systems (PCS), personal digital assistants (PDA's), notebook computers in wireless local area networks (WLAN), wireless metropolitan area networks (WMAN), wireless wide area networks (WWAN), or wireless personal area networks (WPAN, and the like).

With the phenomenal growth of wireless technologies in recent years we are seeing the ubiquitous introduction of multi-radio functionality on devices such as laptops, PDAs and smart phones. Although the present invention is in no way limited to these devices, it may be important for such devices that may be working off batteries (or any other mobile power source as the present invention is not limited to battery powered mobile devices) that they efficiently manage and conserve the power required to operate these multiple radios. These radio devices can be discrete radio devices, reconfigurable radio devices or software based radio devices. The present invention may provide an efficient way to manage the radios, and more specifically, in an embodiment of the present invention, the power of a wireless device, by utilizing the characteristics of available radios and potentially using them in a complementary fashion to dynamically select the most appropriate radio(s) based on systems or users profiles (e.g. battery level, network access and transmission cost) and network conditions (e.g. available bandwidth, quality of service available) using various algorithms and heuristics described below. Although the present invention utilizes batteries and discusses battery levels and network conditions in illustrative examples of the present invention, it is understood that these are but a small fraction of characteristics that may differentiate and complement radios in a wireless device. For example, and not by way of limitation, in addition to battery longevity and network conditions such as available bandwidth and cost as used in illustrative examples herein, factors such as interference minimization, multiplath optimization or base station compatibility may be some additional of many additional characteristics that are intended to be within the scope of the present invention.

Most of the time that a device is “wirelessly connected” to an access-point or base-station it may be to simply exchange control frames in order to maintain the connectivity between the client device and the base-station. Occasionally the client device or the base station exchange data traffic for e-mail access, Internet access, voice-over-IP connection, etc. (although the present invention is not limited to these uses of wireless information transfer and indeed all uses contemplated for wireless information transfer now known or later developed are intended to be within the scope of the present invention). But even when no data traffic is exchanged and to only maintain the connection state, some radio protocols consume an order of magnitude more power than specialized lower power and lower bandwidth radios. Base stations can easily support multiple radios and wireless protocols and the present invention is intended to include, but not be limited to, radio protocols such as wireless local area network (WLAN), wireless wide area network (WWAN), wireless metropolitan area network (WMAN) or wireless personal area network (WPAN) protocols such as the Industrial Electrical and Electronics Engineers (IEEE) 802.11a/b/g, 802.15, 802.16 and 802.18 standards, Bluetooth™, Zigbee, UWB, infrared, etc. (Bluetooth is a registered trademark of the Bluetooth Special Interest Group). It should be understood that the scope of the present invention is not limited by the types of, the number of, or the frequency of the communication protocols articulated herein.

An embodiment of the present invention may utilize the fact that most of the time that a client may be “wirelessly connected” to a base station, the traffic exchanged between these two devices may be for connection control. Under such a case, the present invention may instruct the client device to instead use the low-power/low-bandwidth radio to maintain the connection states, and depending on the user's policy to exchange short messages such as e-mails or non-real-time message over this radio. Although the present invention is not limited to those uses for low-power/low-bandwidth operations. Thus, low-bandwidth and non real-time data traffic may be routed through the low-power/low-throughput radio while the high-power/high-throughput radio may be put to sleep (as opposed to idle) under such cases. It is possible that when there may be a need to send high bandwidth, real-time traffic, or when the low-power/low-throughput radio may be out of range, the high powered radio may be woken-up.

Thus, the present invention may manage radios to work in a complementary fashion and may dynamically select the most appropriate radio(s) based on various parameters, such as required bandwidth for the message, message size, range from the base-station and signal quality, quality of service required for the message, etc, resulting in significant power savings without degradation for the client services. Although the present invention is not limited to the aforementioned parameters.

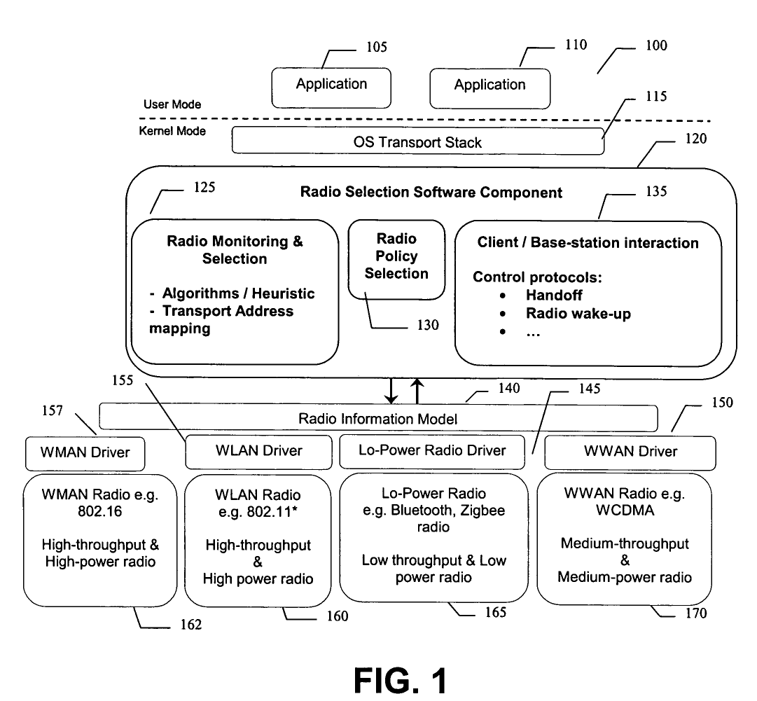

Turning now to the figures, in FIG. 1 is an illustration of the architecture of the software framework of wireless device 100 of an embodiment of the present invention, which may comprise a plurality of radios, such as WWMAN radio 162 with WMAN driver 157, WLAN radio 160 with WLAN driver 155, low power radio 165 with low power radio driver 145 and WWAN radio 170 with WWAN driver 150; and wherein at least two of the plurality of radios 160, 165 and 170 are capable of operating within predetermined parameters. Examples of, but not meant in any way to limit, a high power radio 160 may be an 802.11 radio; and a medium powered radio 170 may be a WCDMA radio; and a low power radio 165 may be a Bluetooth or Zigbee 802.15.4 radio. As shown in FIG. 1 at 120, modules (modules may include, but is not limited to, software processed in a computing device, firmware, ROM, any methodologies or steps to accomplish a result, DSPs, or the like) are capable of dynamically selecting the most appropriate radio, of radios 160, 165 and 170, based on the predetermined parameters.

The following modules 120 may be used to perform the aforementioned functions (although the present invention is not limited to these modules):

Radio Monitoring & Selection 125

Monitoring: May provide continuous monitoring of the currently selected radio(s) usage, signal quality, reachability, throughput and works in conjunction with the radio selection process.

Selection: Set of Methodologies/heuristics or the like (although the present invention is not limited to these selection techniques) used to determine when to select the most appropriate radio. An example of such a methodology is deep packet inspection of the transmitted packet in order to determine the type of packet, e.g. RTP (Real-Time Protocol) packet, packet carrying AN type of traffic, etc. (Although the present invention is not limited to this methodology and it is anticipated that many methodologies/heuristics may be employed by the present invention depending on the parameters set for radio coordination).

Applications 105 and 110 may also classify the type of traffic to be routed to the appropriate radios 160,165 and 170. For example, and not by way of limitation, consecutive transmission of data to the same destination address within a certain time-period, i.e. the client is sending a large file and the wireless device 100 should switch to high-power/high-throughput radio 160; or the present invention may monitor the transmit queue size, and if high-mark threshold is reached, then switch to high-power/high-throughput radio 160. It is understood that the term “high” or “medium” or “low” throughout in the present application are relative terms. Further, it is understood that power levels are infinite and all power levels are anticipated to be included in the present invention and use of the term “high” or “low” and the like are relative to other power levels and not meant to be limited to a predefined power threshold.

Transport address mapping 115: This block provides an address mapping facility so the client applications 105 and 110 may talk with the initial address it has opened the connection on, regardless of the radio being used.

Radio Policy Selection 130 may provide for a high level, user level type policies that will help in the decision process, for example, and not by way of limitation, “send all e-mail traffic on the low-power/low-bandwidth radio 165 regardless of battery power level”.

Client/Base-station interaction 135, may include control protocols such as radio selection and wake-up. This may be the protocol used between the client device and the base-station. This protocol may be above the MAC layer so the MAC of the different radios remains unmodified. It should be noted that for efficiency both sides may be able to select the appropriate radio to be used on the remote device. Although the present invention is not limited in this respect. For example, if the Voice-over-IP call request comes from the network to the client device, the base station may instruct the client device to switch to the high-power/high-throughput radio 160 as soon as possible. If the base-station doesn't have the ability to do this, the client device may need to initiate the switch to the high-power/high-bandwidth radio for incoming traffic (and assuming incoming traffic will continue to flow in) and extra latency may be added. This protocol helps wireless devices maintain the connection state and may be used to instruct the other side to switch over to the other radio.

The control protocol of the client/base station interaction 135 may also include handoff/roaming between the networks. For example, and not by way of limitation, low-power/low-throughput radio 165 may have a shorter range than the high-power/high-throughput radio 160 counterpart. When traveling through a building the user may need to perform a vertical handoff from the low-power radio 165 to the high-power radio 160, then perform a series of high-power radio 160 handoffs until it reaches its final destination where the user may then perform a vertical handoff from the high-power radio 160 to the low-power radio 165 if the user is within range of the low-power radio.

A Radio Information Model (RIM) 140, as known to those of ordinary skill in the art, exposes a uniform view of the system's wireless devices, their properties and protocols, using a well defined schema. The aforementioned Radio Monitoring & Selection” 125 modules may use the RIM 140 to gather relevant information describing the radios 160, 165 and 170 (e.g. transmit power, etc.) and controlling them.

Thus, the predetermined parameters may be predetermined power levels and the modules may select the most appropriate radio based on power requirements determined by systems profiles. In addition to or in lieu of the predetermined power levels, the modules 120 may select the most appropriate radio based on requirements determined by network conditions. The network conditions may include available bandwidth of the network.

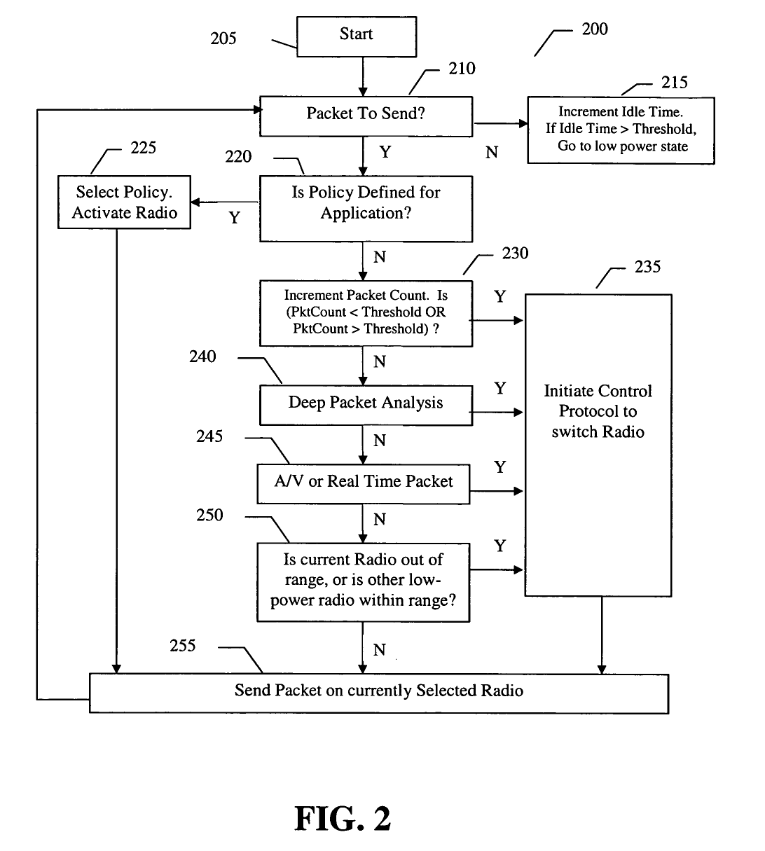

Turning now to FIG. 2, shown generally at 200, is a technique of the radio monitoring and selection 125 of the present invention. The process begins at 205 and determines if there is a packet to send at 210. If not, then at 215, increment Idle Time and if Idle Time>Threshold, go to low power state. If yes at 210, then determine if policy is defined for the application at 220. If yes at 220, then at 225, select a policy and activate the radio and proceed to step 255 to send packet on currently selected radio. If no at 220, then at 230 increment packet count and determine if (PktCount<Threshold OR PktCount>Threshold). If yes at 230, then initiate control protocol to switch radio at 235 and proceed to step 255 to send packet on currently selected radio. If no at 230, then at 240 a deep packet analysis is completed and if yes at 240, the process proceeds to 235 and again to 255 to send packet on currently selected radio. If no at 240, then at 245 a determination is made if the packet is an A/V or Real Time Packet. If yes at 245, then the process proceeds to 235 and again to 255 to send packet on currently selected radio. If no at 245, then at 250 a determination is made if current radio is out of range, or is other low-power radio within range. If yes at 250, the the process proceeds to 235 and to 255 to send packet on currently selected radio. If no at 250, then the process proceeds directly to 255 to send packet on currently selected radio.

Also provided by the current invention is an article comprising a storage medium having stored thereon instructions, that, when executed by a computing platform, results in the optimization of a wireless device's 100 power management by dynamically selecting a most appropriate radio among a plurality of radios 160, 165, 170 associated with the wireless device 100 and capable of operating within predetermined parameters. The selection may be accomplished by modules 120 capable of dynamically selecting the most appropriate radio based on the predetermined parameters. As above, the predetermined parameters may be predetermined power levels and the modules may select the most appropriate radio based on power requirements determined by systems profiles; or the predetermined parameters may be predetermined power levels and the modules 120 select the most appropriate radio based on power requirements determined by network conditions.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. A wireless device, comprising:
a plurality of radios, wherein at least two of said plurality of radios are capable of operating within predetermined parameters; and
said wireless device capable of dynamically selecting the most appropriate radio based on said predetermined parameters.

2. The wireless device of claim 1, wherein said predetermined parameters are predetermined power levels and modules select said most appropriate radio based on power requirements determined by systems or user's profiles.

3. The wireless device of claim 1, wherein said predetermined parameters are predetermined power levels and said software components select said most appropriate radio based on power requirements determined by network conditions.

4. The wireless device of claim 2, wherein said systems profiles are a battery level of said wireless device.

5. The wireless device of claim 3, wherein said network conditions are available bandwidth of said network.

6. The wireless device of claim 1, wherein said wireless device is capable of:
radio monitoring and radio selection;
radio policy processing and selection; and
client/base-station interaction.

7. The wireless device of claim 6, wherein said radio monitoring and radio selection uses a Radio Information Model (RIM).

8. The wireless device of claim 1, wherein said plurality of radios are a hierarchy of radios, said hierarchy based upon power, range or throughput and said most appropriate radio is selected from said hierarchy of radios.

9. The wireless device of claim 6, wherein said radio selection uses a set of heuristics used to determine when to select the most appropriate radio.

10. The wireless device of claim 9, wherein said wireless device is capable of a deep packet inspection of a transmitted packet, inspection of packet size to send or inspection of periodicity of traffic in order to determine the type of packet.

11. The wireless device of claim 6, wherein said modules further comprise transport address mapping.

12. The wireless device of claim 6, wherein said modules comprise:
(a) determining if there is a current packet to send, and if not, enabling a low power radio, and if so, determining if said wireless device is currently on a high power radio, and if it is, transmitting said packet on said high power radio;
(b) incrementing a packet count if said wireless device is not currently on said high power radio and determining if said packet count is above a predetermined threshold;
(c) initiating a control protocol to switch to said high power radio for a next packet once said predetermined threshold is met;
(d) determining, if said threshold in step (c) is not met, whether or not to do a deep packet inspection and, if not, send said current packet on said low power;
(e) determining, if a deep packet inspection is to be done in step (d), if the current packet is a real time packet, and if not, sending current packet on said low power radio; and
(f) initiating a control protocol to switch to said high power radio for a next packet if it is determined in step (d) to do a deep packet inspection and it is determined in step (e) that said current packet is a real time packet.

13. A method of selecting a radio from a plurality of radios capable of operating within predetermined parameters in a wireless device, comprising:
dynamically selecting the most appropriate radio based on said predetermined parameters determined by modules.

14. The method claim 13, further comprising selecting by said modules said most appropriate radio based on power requirements determined by systems or users' profiles.

15. The method claim 13, further comprising selecting by said modules said most appropriate radio based on power requirements determined by network conditions.

16. The method of claim 13, further comprising monitoring and selecting; selecting a radio policy; and interacting between said client and said base-station.

17. The method claim of claim 16, wherein said radio monitoring and radio selection uses a Radio Information Model (RIM).

18. The method of claim 16, further comprising using control protocols for interaction between said client and said base station and wherein said control protocols further comprises selecting a radio and waking-up and handing off and roaming between networks.

19. The method of claim 13, further comprising using heuristics to determine when to select the most appropriate radio.

20. A method, comprising:
(a) determining, in a wireless device, if there is a current packet to send, and if not, enabling a low power radio associated with said wireless device, and if so, determining if said wireless device is currently on a high power radio associated with said device, and if it is, transmitting said packet on said high power radio;
(b) incrementing a packet count if said wireless device is not currently on said high power radio and determining if said packet count is above a predetermined threshold;
(c) initiating a control protocol to switch to said high power radio for a next packet once said predetermined threshold is met;
(d) determining, if said threshold in step (c) is not met, whether or not to do a deep packet inspection and, if not, sending said current packet on said low power radio;
(e) determining, if a deep packet inspection is to be done in step (d), if the current packet is a real time packet, and if not, sending said current packet on said low power radio; and
(f) initiating a control protocol to switch to said high power radio for a next packet if it is determined in step (d) to do a deep packet inspection and it is determined in step (e) that the current packet is a real time packet.

21. An article comprising a storage medium having stored thereon instructions, that, when executed by a computing platform, results in a wireless device's power management by dynamically selecting a most appropriate radio among a plurality of radios associated with said wireless device and capable of operating within predetermined parameters, said selection accomplished by software components capable of dynamically selecting the most appropriate radio based on said predetermined parameters.

22. The article of claim 21, wherein said predetermined parameters are predetermined power levels and said software components select said most appropriate radio based on power requirements determined by systems profiles.

23. The article of claim 21, wherein said predetermined parameters are predetermined power levels and said software components select said most appropriate radio based on power requirements determined by network conditions.
